(19) United States
(12) Patent Application Publication
(10) Pub. No.: US 2004/0149026 A1
(43) Pub. Date: Aug. 5, 2004

(54) Method and devices for quantitative evaluation of coatings

(75) Inventors: Radislav Potyrailo, Niskayuna, NY (US); George F. Medford, Ballston Lake, NY (US); James Cawse, Pittsfield, MA (US)

Correspondence Address: GENERAL ELECTRIC COMPANY, GLOBAL RESEARCH, PATENT DOCKET RM. BLDG. K1-4A59, SCHENECTADY, NY, 12301-0008, US

(73) Assignee: General Electric Company, Niskayuna, NY

(21) Appl. No.: 10/358,680

(22) Filed: Feb. 5, 2003

(51) Int. Cl. G01N 17/00

(52) U.S. Cl. 73/150 R

(57) ABSTRACT

In one aspect of the invention, a method and system are provided for analyzing the adhesion of a coating. The method comprises the steps of directing light into the coating, using an image detector to collect light and fluorescence images from the coating/substrate combination, and applying a set of analysis tests to the collected light and fluorescence images. In another aspect of the invention, a method and system are provided for quantitatively analyzing the spatially resolved curing condition of a coating. The method comprises the steps of providing a coating with a fluorophore that is responsive to a defined curing condition, applying the coating onto a substrate, and using the defined curing process to cure the coating. The method comprises the further steps of using an image detector to collect fluroescence image from the coating, and applying a set of analysis tests to the fluorescence image.

### STATEMENT REGARDING FEDERALLY SPONSORED RESEARCH

The U.S. Government may have certain rights in this invention pursuant to NIST contract number 70NANB9H3038.

### BACKGROUND OF THE INVENTION

This invention generally relates to methods and systems for the quantitative analysis of coatings. More specifically, the invention relates to methods and systems for the quantitative evaluation of adhesion, cured conditions and other spatial inhomogeneities of coatings.

Different known types of tests for the evaluation of inhomogeneities of coatings are known in the art. Coating adhesion tests include micro-scratch test, pull test, peel test, supersonic water jet test, stress-wave emission test, crosscut test, contrast analysis test, and many others. The standard test methods include tape test, scrape test, peel test, pull-off test, and water immersion test. The quantitation of adhesion is typically performed by visualizing the regions of coating removed from a substrate and relating the area of removed coating to the area of intact coating.

Evaluation of inhomogeneities in the curing condition of a coating is problematic because most existing evaluation methods provide only spatially averaged information about the curing condition of a whole coating. Attenuated total reflection infrared spectroscopy is potentially useful for probing different regions of coatings. However, this method requires a contact with the analyzed sample and thus is difficult for adaptation for a high throughput analysis of coatings with different degrees of cure including partially cured coatings.

### SUMMARY OF THE INVENTION

in one aspect of the invention, a method and system are provided for quantitatively analyzing, the adhesion of a coating deposited onto a substrate. The method comprises the steps of directing light into the coating, providing an image detector, using the image detector to collect light and fluorescence images from the coating/substrate combination, and applying a predetermined set of image analysis tests to the collected light and fluorescence images to quantify the adhesion of the coating to the substrate. For example, in the image analysis of the reflected light image of a cross hatched coating, a number of cross-hatch features may be determined that include, but are not limited to, pattern orientation, pattern pitch, pattern defects, and others. As another example, in the image analysis of the fluorescent light image of the cross hatched coating, determination of coating edges may be performed and the cross-hatch features determined from the reflected light image are applied to the fluorescence image. A further step of analysis may be used that involves quantitation of regions with removed coating. Such combination of reflected light and fluorescence image analysis provides an improved ability in quantitation of adhesion loss of coating regions.

In another aspect of the invention, a method and system are provided for quantitatively analyzing the spatially resolved curing condition of a coating deposited onto a substrate. The method comprises the steps of providing a coating with a fluorophore that is responsive to a defined curing condition, applying the coating onto the substrate, and using the defined curing process to cure the coating. The method comprises the further steps of providing an image detector, using the image detector to collect at least one fluorescence image from the coating during the coating process, and applying a set of image analysis tests to the collected fluorescence image to quantify the curing condition of the coating. For example, in the image analysis of the fluorescent light image of the coatings, the spectral, polarization, and temporal properties of the florophore may be used to determine the curing conditions of the coatings.

Further benefits and advantages of the invention will become apparent from a consideration of the following detailed description, given with reference to the accompanying drawings, which specify and show preferred embodiments of the invention.

### BRIEF DESCRIPTION OF THE DRAWINGS

FIG. 1 illustrates a procedure for analyzing adhesion-tested regions of coatings.

FIGS. 2, 3 and 4 depict systems that may be used to analyze coatings or coating elements.

FIG. 5 shows a method for spatially resolving analysis of curing condition of coatings.

FIGS. 6, 7 and 8 depict, respectively, reflected light, fluorescence analog, and fluorescence photon counting images that were collected using the present invention.

FIG. 9 illustrates a visualization summary of adhesion analysis of a coating array using the method and system of the present invention.

### DETAILED DESCRIPTION OF THE PREFERRED EMBODIMENTS

The present invention, generally, relates to methods and systems for the quantitative analysis of inhomogeneities, such as adhesion-loss regions and regions of different curing conditions in organic coatings. While the invention has wide applicability to the analysis of coatings generally, it is particularly useful for analyzing transparent coatings.

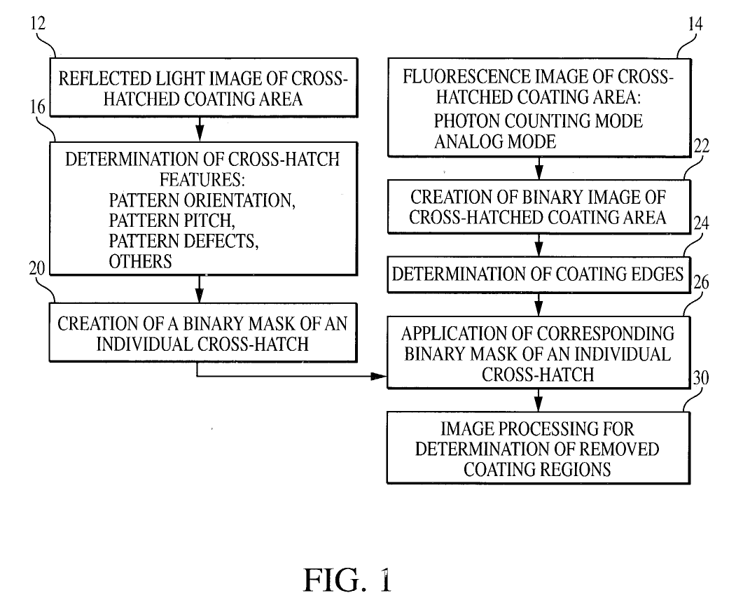

A flow chart of a preferred method for the quantitative analysis of adhesion-tested regions of coatings is illustrated in FIG. 1. This analysis method comprises the steps, represented at 12 and 14, of collecting reflected light and fluorescence images from each individual coating region with a suitable imaging detector. Then a set of image analysis steps are applied to the collected reflected light and fluorescence images. More specifically, at step 16, in the image analysis of the reflected light image of the cross hatched coating, a number of cross-hatch features are determined that include but are not limited to pattern orientation, pattern pitch, pattern defects, and others. Then, at step 20, a binary mask of an individual cross-hatch is created. At steps 22 and 24 in the image analysis of the fluorescent light image, a binary image of cross-hatched coating areas is created, and coating edges are determined. At step 26, the cross-hatch features determined from the reflected light image are applied to the fluorescence image. A further step 30 of the preferred analysis is to quantify regions with removed coating. As described above, the method of this invention uses light reflected from the coating/substrate combination. It may be noted that this method may also employ, as a substitute for or in condition with the reflected light, light scattered from the coating/substrate.

Determination of adhesion of coatings, for example, with variable thickness is performed when fluorescence images are taken before the cross-hatch is applied and adhesion-loss test is done and after the cross-hatch and adhesion-loss test. A ratio of these images provides a thickness-independent spatial map of coating adhesion loss. The reflected light images are also taken before and after the cross-hatch and adhesion-loss test to compensate for any variation in coating orientation, tilt, and any other non-adhesion related imaging features.

For adhesion-loss determinations, fluorescence imaging is performed by observing preferential fluorescence from coating regions or from a substrate. Fluorescence is provided either by doping the coating with a negligible amount of a fluorophore or observing a native fluorescence of the coating material itself. Similarly, a substrate may contain fluorescent species that are imaged. This fluorescence is provided from the doped fluorophore into the substrate or a native fluorescence of the substrate is used. In case of the detection of substrate fluorescence, the excitation or emission or both wavelengths are attenuated by the regions with intact coating.

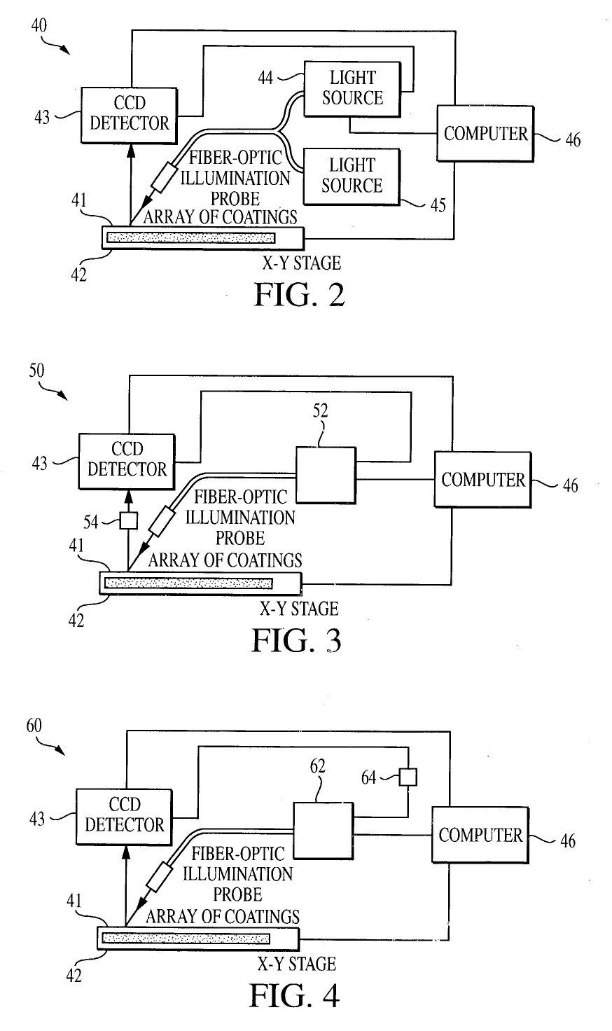

FIG. 2 schematically illustrates an automated system 40 for quantitation of adhesion loss of a plurality of coating elements from a combinatorial library. In the illustration, one or more transparent coatings and substrates 41 are supported for movement on a moveable stage 42. An imaging detector 43 such as a CCD camera is coupled to two types of light sources, such as a source 44 for reflected light illumination and a source 45 for fluorescence imaging. Upon operation of source 44, a sequence of images from coating elements 41 is collected for determination of cross-hatch patterns. Upon operation of source 45, a sequence of images from coating elements 41 is collected for determination of adhesion loss. FIG. 2 also shows a computer 46 processing signals from detector 43.

System 40 of FIG. 2 may be modified to provide an automated system for quantitation of adhesion loss of a plurality of coating elements from a combinatorial library. This modified system is shown in FIG. 3. Specifically, system 50 includes a single light source 52, rather than the two light sources 44 and 45 of system 40, a set of optical filters 54, and the rest of the components of the system shown in FIG. 2. To collect different types of images, the set of optical filters 54 are positioned in front of the camera 43. Different filters are used for reflected light and fluorescence imaging.

In yet another embodiment, illustrated in FIG. 4, an automated system 60 is provided for quantitation of adhesion loss of a plurality of coating elements from a combinatorial library. System 60 comprises a single light source 62, a delay generator 64, and the rest of the components of the system 40 shown in FIG. 2. To collect fluorescent images, the delay generator 64 controls the interval between the light pulse and image acquisition.

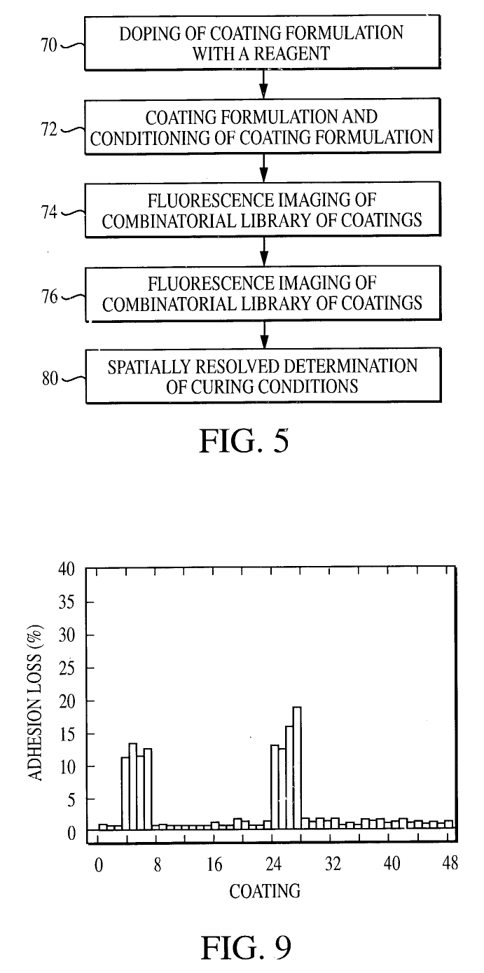

FIG. 5 illustrates a flow chart for a preferred method for quantitative spatially resolved analysis of curing condition of coatings. In this analysis method, at step 70, a coating is doped with a fluorophore that is responsive to the curing condition, and at step 72 the coating formulation is applied and conditioned. As represented by steps 74 and 76, at least a plurality of, and preferably more, fluorescence images are obtained, using an imaging detector, from each individual coating region during the curing process. At step 80, the fluorescent light image of the coatings are analyzed to determine curing conditions of the coatings based on the spectral, polarization, and temporal properties of the fluorophore. Here too it may be noted that the method of this invention can use light scattered from the coating/substrate combination. The collected scattered light may be used as a substitute for, or in combination with, the light reflected from the coating/substrate combination.

Below is a partial list of commercially available fluorophores that may be used for monitoring of curing in coatings and polymers.

4-(Dimethylamino)-4′-nitrobiphenyl

4-(dimethylamino)-4′-nitrostilbene

p,p′-diaminoazobenzene

N-(5-(dimethylamino)naphthalene-1-sulfonyl)aziridine

1-(4-dimethylaminophenyl)-6-phenyl-1,3,5-hexatriene

6-propionyl-2-(dimethylamino)naphthalene

4-(dimethylamino)-4′-nitrophenylbutadiene

4-Dicyanovinyl-N,N-dimethylaniline

1,5-naphthyldiamine

pyrene

2(4-(4-(dimethylamino)phenyl)-1,3-butadienyl)-3-ethylbentzothiatzole p-toluenesulfonate

4-(dicyanomethylene)-2-methyl-6-(4-dimethylaminostyryl)-4Hpyran

2-(4-(dimethylamino)styryl)-1-methylquinoliniumiodide

7-(Dimethylamino)-4-(trifluoromethyl)coumarin

10,6-dodecanoyl-2-(dimethylamino)naphthalene

4-dicyanovinyl-N,N-dimethylamino-1-naphthalene

5-(dimethylamino) naphthalene-1-sulfonamide

Below is a partial list of commercially available fluorophores that may be used for quantitative evaluation of coatings defects.

5,9-Diaminobenzo(a)phenoxazonium Perchlorate

4-Dicyanomethylene-2-methyl-6-(p-dimethylaminostyryl)-4H-pyran

1,1′-Diethyl-2,2′-carbocyanine Iodide

3,3′-Diethyl-4,4′,5,5′-dibenzothiatricarbocyanine Iodide

1,1′-Diethyl-4,4′-dicarbocyanine Iodide

3,3′-Diethyl-9,11-neopentylenethiatricarbocyanine Iodide

1,3′-Diethyl-4,2′-quinolyloxacarbocyanine Iodide

3-Diethylamino-7-diethyliminophenoxazonium Perchlorate

7-Diethylamino-4-methylcoumarin

7-Diethylamino-4-trifluoromethylcoumarin

7-Diethylaminocoumarin

3,3′-Diethyloxadicarbocyanine Iodide

3,3′-Diethylthiatricarbocyanine Iodide

4,6-Dimethyl-7-ethylaminocoumarin

2,2′-Dimethyl-p-quaterphenyl

2,2-Dimethyl-p-terphenyl

7-Dimethylamino-1-methyl-4-methoxy-8-azaquinolone-2

7-Dimethylamino-4-methylquinolone-2

7-Dimethylamino-4-trifluoromethylcoumarin

2,5-Diphenylfuran

2,5-Diphenyloxazole

4,4′-Diphenylstilbene

1-Ethyl-4-(4-(p-Dimethylaminophenyl)-1,3-butadienyl)-pyridinium Perchlorate

9-Ethylamino-5-ethylamino-10-methyl-5H-benzo(a)phenoxazonium Perchlorate

7-Ethylamino-6-methyl-4-trifluoromethylcoumarin

7-Ethylamino-4-trifluoromethylcoumarin

1,1′,3,3,3,3′-Hexamethyl-4,4′,5,5′-dibenzo-2,2′-indotricarboccyanine Iodide

1,1′,3,3,3′,3′-Hexamethylindotricarbocyanine Iodide

2-Methyl-5-t-butyl-p-quaterphenyl

3-(2′-N-Methylbenzimidazolyl)-7-N,N-diethylaminocoumarin

Rhodamine 700

Oxazine 750

Rhodamine 800

IR 125

IR 144

IR 140

IR 132

IR 26

IR 5

In an actual reduction to practice of the present invention, several liquid coating formulations were deposited using a liquid handling robot (Packard Instrument Co., Model Multiprobe II, Meriden, Conn.) onto a polycarbonate substrate to produce an array of 48 coatings. Coating deposition was performed using 8-microliter volumes of coating formulations in methoxypropanol at concentration of 20% solids, pipetting them into separate spatial locations provided with a 48-well mask, and UV curing the film. For visualization of adhesion of transparent coatings, one or several luminophores were incorporated into liquid coating formulations. The concentration of luminophore in polymer solution was about 0.001-5000 ppm. Luminescent dyes selected for doping the coating were inert luminophores, Lumogen F (BASF), types Yellow 083, Orange 240, Red 300, or Violet 570.

The automated adhesion analysis system included a laser light source (532-nm Nd: YAG laser), an intensified CCD (ICCD) camera, and an X-Y translation stage. For image acquisition and analysis, software packages, LabVIEW, IMAQ Vision Builder and Advanced IMAQ Vision from National Instruments (Austin, Tex.) and Matlab (Mathworks Inc., Natick, Mass.), were used. IMAQ Vision Builder software provides the capability for the development of customized analysis tools using script commands.

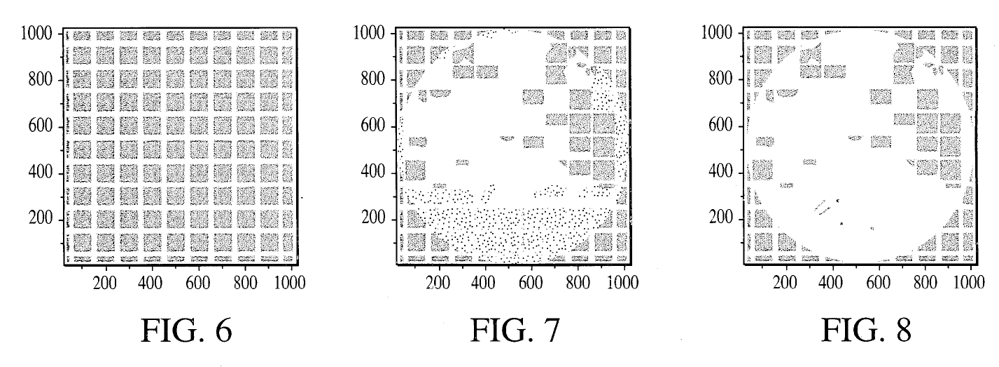

FIGS. 6, 7 and 8, respectively, depict a set of reflected light, fluorescence analog, and fluorescence photon counting images collected with the system shown in FIG. 2. These images were used for determination of adhesion loss of the coating element. FIG. 9 shows a visualization summary of adhesion analysis of a coating array using the method and the system of the present invention.

While it is apparent that the invention herein disclosed is well calculated to fulfill the objects stated above, it will be appreciated that numerous modifications and embodiments may be devised by those skilled in the art, and it is intended that the appended claims cover all such modifications and embodiments as fall within the true spirit and scope of the present invention.

1. A method of quantitatively analyzing the adhesion of a coating deposited onto a substrate, comprising the steps of:
directing light onto the coating;
providing an image detector;
using the image detector to collect light and fluorescence images from the coating/substrate combination; and
applying a predetermined set of image analysis tests to the collected light and fluorescence images to quantify the adhesion of the coating to the substrate.

2. A method according to claim 1, wherein the applying step includes the step of analyzing the collected light to identify predetermined features.

3. A method according to claim 1, wherein the applying step includes the step of analyzing the collected light to identify a feature of a predetermined pattern on the coating.

4. A method according to claim 3, wherein the predetermined pattern is a cross-hatched pattern.

5. A method according to claim 1, wherein the applying step includes the step of analyzing the fluorescence images to identify predetermined features of the coating.

6. A method according to claim 5, wherein the analyzing step includes the step of analyzing the fluorescence images to determine edges of the coating.

7. A method according to claim 1, wherein the applying step includes the step of analyzing the collected light and fluorescence images to identify regions of the substrate where the coating has been removed.

8. A method according to claim 1, wherein the fluorescence imaging is performed by observing preferential fluorescence from coating regions, substrate, or adhesion-promoter layer between the substrate and coating.

9. A method according to claim 1, wherein fluorescence imaging is performed by observing preferential fluorescence from coating regions.

10. A method according to claim 1, wherein the coating is made from a coating formulation and the detected fluorescence originates from a fluorescent tag doped into the coating formulation.

11. A method according to claim 1, wherein the coating is made from a coating formulation having at least one active component, and the detected fluorescence is a native fluorescence of at least one of the active components of the coating formulation.

12. A method according to claim 1, wherein for adhesion-loss determinations, fluorescence imaging is performed by observing preferential fluorescence from substrate.

13. A method according to claim 1, wherein the detected fluorescence originates from a fluorescent tag doped into substrate.

14. A method according to claim 1, wherein the detected fluorescence is native fluorescence of at least one of the active components of substrate.

15. A method according to claim 1, wherein the step of using an image detector includes the step of using the image detector to collect light reflected from the coating/substrate.

16. A method according to claim 1, wherein the step of using the image detector includes the step of using the image detector to collect light reflected from the coating/substrate.

17. A method of quantitatively analyzing the adhesion of a coating deposited onto a substrate, comprising the steps of:
directing light onto the coating;
providing an image detector;
using the image detector to collect reflected light and fluorescence images from the coating/substrate combination; and
applying a predetermined set of image analysis tests to the collected light and fluorescence images to quantify the adhesion of the coating to the substrate, including the steps of:
i) analyzing the collected light to identify a cross-hatched pattern on the coating, and
ii) analyzing the fluorescence images to determine edges of the coating; and
wherein the image processor analyzes the collected light to identify a cross-hatched pattern on the coating, and analyzes the fluorescence images to determine edges of the coating.

18. A system for quantitatively analyzing the adhesion of a coating to a substrate, the system comprising:
a light source to direct light onto the coating to reflect light and to generate fluorescence images from the coating;
an image detector to collect light and fluorescence images from the coating; and
an image processor to apply a set of image analysis tests to the collected light and fluorescence images to quantify the adhesion of the coating to the substrate.

19. A system according to claim 18, wherein the image processor analyzes the reflected light to identify a feature of a pattern on the substrate.

20. A system according to claim 19, wherein the pattern is a cross-hatched pattern.

21. A system according to claim 18, wherein the image processor analyzes the fluorescence images to identify a predetermined feature of the coating.

22. A system according to claim 18, wherein the image processor identifies regions of the substrate where the coating has been removed.

23. A system according to claim 18, wherein the fluorescence imaging is performed by observing preferential fluorescence from coating regions, substrate, or adhesion-promoter layer between the substrate and coating.

24. A system according to claim 18, wherein fluorescence imaging is performed by observing preferential fluorescence from coating regions.

25. A system according to claim 18, wherein the coating is made from a coating formulation and the detected fluorescence originates from a fluorescent tag doped into the coating formulation.

26. A system according to claim 18, wherein the coating is made from a coating formulation having at least one active component, and detected fluorescence is a native fluorescence of at least one of the active components of the coating formulation.

27. A system according to claim 18, wherein for adhesion-loss determinations, fluorescence imaging is performed by observing preferential fluorescence from substrate.

28. A system according to claim 18, wherein the detected fluorescence originates from a fluorescent tag doped into the substrate.

29. A system according to claim 18, wherein the detected fluorescence is native fluorescence of at least one of the active components of substrate.

30. A system for quantitatively analyzing the adhesion of a coating formulation deposited onto a substrate said coating formulation being doped with a fluorophore tag, the system comprising:
a light source to direct light onto the coating;
an image detector to collect reflected light and fluorescence images from the coating; and
an image processor to apply a set of image analysis tests to the collected light and fluorescence images to quantify the adhesion of the coating to the substrate;
wherein fluorescence imaging is performed by observing preferential fluorescence from coating regions, and the detected fluorescence originates from the fluorophore tag doped into the coating formulation.

31. A method of quantitatively analyzing the spatially-resolved curing condition of a coating deposited onto a substrate, comprising the steps of:
providing a coating with a fluorophore that is responsive to a defined curing condition;
applying the coating onto the substrate;
using the defined curing process to cure the coating;
providing an image detector;
using the image detector to collect at least one fluorescence image from the coating during the curing process; and
applying a set of image analysis tests to the collected fluorescence image to quantify the curing condition of the coating.

32. A method according to claim 31, wherein the step of applying a set of image analysis tests includes the step of applying the set of image analysis tests to determine the curing condition of the coating based on defined properties of the fluorophore.

33. A method according to claim 32, wherein said defined properties are selected from the group consisting of spectral, polarization and temporal properties of the fluorophore.

34. A method of quantitatively analyzing the spatially-resolved curing condition of a coating deposited onto a substrate, comprising the steps of:
providing a coating formulation with a fluorophore that is responsive to a defined curing condition;
applying the coating formulation onto the substrate;
using the defined curing process to cure the coating formulation;
providing an image detector;
using the image detector to collect at least one fluorescence image from the coating during the curing process; and
applying a set of image analysis tests to the collected fluorescence image to determine the curing condition of the coating based on defined properties of the fluorophore, said defined properties selected from the group consisting of spectral, polarization and temporal properties of the fluorophore;
wherein fluorescence imaging is performed by observing preferential fluorescence from coating regions, and the detected fluorescence originates from a fluorophore of the coating formulation.

35. A system for quantitatively analyzing the spatially-resolved curing condition of a coating on a substrate, said coating being doped with a fluorophore that is responsive to a defined curing condition, the system comprising:
a light source to direct light onto the coating, wherein the coating generates fluorescence images;
an image detector to collect at least one fluorescence image from the coating; and
an image processor to apply a set of image analysis tests to the collected fluorescence image to quantify the adhesion of the coating to the substrate.

36. A system according to claim 35, wherein the image processor determines the curing condition of the coating based on defined properties of the fluorophore.

37. A system according to claim 36, wherein said defined properties are selected from the group consisting of spectral, polarization and temporal properties of the fluorophore.

38. A system for quantitatively analyzing the spatially-resolved curing condition of a coating on a substrate, said coating being doped with a fluorophore that is responsive to a defined condition, the system comprising:
a light source to direct light onto the coating, wherein the coating generates fluorescence images;
an image detector to collect at least one fluorescence image form the coating; and
an image processor to apply a set of image analysis tests to the collected fluorescence image to determine the adhesion of the coating to the substrate based on defined properties of the fluorophore, said defined properties selected from the group consisting of spectral, polarization and temporal properties of the fluorophore.
